(19) United States
(12) Patent Application Publication
(10) Pub. No.: US 2006/0291003 A1
(43) Pub. Date: Dec. 28, 2006

(54) Tabbed document copying systems and methods

(75) Inventor: John A. Sklenar, Rochester, NY (US)

Correspondence Address: FREDERICK W. GIBB, III;GIBB INTELLECTUAL PROPERTY LAW FIRM, LLC, 2568-A RIVA ROAD, SUITE 304, ANNAPOLIS, MD, 21401, US

(73) Assignee: Xerox Corporation

(21) Appl. No.: 11/165,452

(22) Filed: Jun. 23, 2005

(51) Int. Cl. H04N 1/04

(52) U.S. Cl. 358/474; 358/3.28

(57) ABSTRACT

Embodiments herein add tab information to a tab template. The tab template is then printed and inserted between pages of a printed document by the user. Then this tab template-containing document can be scanned in a single pass to identify the location of the tab template within the pages of the tab template-containing document. Thus, when the scanned document is processed through a printing device, a tabbed page is inserted at the location of the tab template in printed copies of the tab template-containing document.

### BACKGROUND

Embodiments herein generally relate to copying and printing systems that operate with tabbed pages. Conventional systems require substantial user intervention to include tabbed pages within multi-page documents. For example, some conventional systems require the user to perform a first printing operation for the non-tabbed pages and a second printing operation for the tabbed pages, after which the user must manually insert the tabbed pages at the correct location within the non-tabbed pages. Such conventional systems are cumbersome and illustrate the difficulty of automating the process of creating documents that include tabbed pages.

### SUMMARY

Method embodiments herein add tab information to a tab template. For example, this tab information could comprise tab modulus, tab location, and text to be printed on the tab of the tabbed page. This could be anything, such as an image or text that doesn't all go onto the tab. The user can put something on the tab, but this is not a requirement. The tab template is then printed and inserted between pages of a printed document by the user. Then all of the tab template-containing document is scanned in a single, continuous scanning step or pass to identify the location of all the tab templates within the pages of the tab template-containing document. Thus, when the scanned document is processed through a printing device, a tabbed page is inserted at the location of the tab template in printed copies of the tab template-containing document.

The scanning identifies pages of the printed copies between which the tabbed page will be inserted by noting a relative position of the tab template within the pages of the tab template-containing document. In addition, the scanning process correlates the tab information with the location of the tab template such that the tab information is printed on the tabbed page. The tab template contains machine-readable markings identifying the tab template as a tab template page. The markings also identify the media to be marked on.

A system embodiment herein comprises a processor, storage that stores the tab template, a graphic user interface used to receive tab information to be added to the tab template, a printer used to print the tab template, and a scanner that scans the tab template-containing document.

The tab template contains scanner-identifiable markings identifying the tab template as a tab template page. Under control of the processor, the scanner or a controller can identify the location of the tab template within pages of the tab template-containing document. The scanner or controller so identifies pages of the printed copies between which the tabbed page will be inserted by noting a relative position of the tab template within the pages of the tab template-containing document when scanning the tab template-containing document. The scanner correlates the tab information with the location of the tab template such that the tab information is printed on the tabbed page.

The printer inserts a tabbed page at a location of the tab template in printed copies of the tab template-containing document. The tab information comprises text and/or other items to be printed on a tab of the tabbed page.

Therefore, embodiments herein substantially automate the process of preparing and copying documents that include tabbed pages. With the embodiments herein, the user only needs to insert the tab template sheet at the correct location within a printed document. After this simple operation, the document can be handled automatically from that point forward. For example, once the user creates the tab template-containing document, the user only needs to place the tab template containing-document within the scanner of a copier apparatus and press the start button. Thereafter, the copier will automatically print the tabbed and non-tabbed pages and insert the tabbed pages at the appropriate location(s) within the document.

These and other features are described in, or are apparent from, the following detailed description.

### BRIEF DESCRIPTION OF THE DRAWINGS

Various exemplary embodiments of the systems and methods described in detail below, with reference to the attached drawing figures, in which:

FIG. 1 is a flow diagram illustrating method embodiments herein; and

FIG. 2 is a schematic representation of system embodiments herein.

### DETAILED DESCRIPTION

As described above, the process of preparing and copying tabbed documents is complicated, cumbersome, and time-consuming. In order to address some of these issues, various systems have been developed. One such system is the Build Job System and another system is the Exception Pages System. These systems are not necessarily conventional known, and are not considered to be prior art. While these systems provide solutions to the process of printing and copying tabbed documents, the embodiments herein improve upon such systems.

With the Build Job System, when a user desires to print or copy a document containing tabbed sheets, the user acquires a tab template that only allows the user to specify the text image, etc. that may be on the tab or other portions of the tabbed sheet. Then, the user prints the document and the tab templates. Next, the user must separate the document into segments. Each segment consists of contiguous sections of the document that will be printed on the same media. The user places each segment of the document into the document handler or scanner and selects the media that the deposited segments of the document will be printed on. Therefore, when a tab template is inserted into the document handler, a tab-type media will be selected. This process is repeated for each segment of the document. Once this process is completed, the document can be sent to a printer or copier to be printed.

The Exception Pages System is similar to the Build Job System in that the user prints the tab templates that contain the text for the tab and the user inserts the tab templates at the appropriate locations within the document. The user must then identify the locations of the tab templates (by page number) and the media to be used for the document pages and the tabbed pages. This information is then entered into the Exception Pages System. At this point, the job can be sent to the printer or copier.

Both these systems require the user to manually identify the physical location of the tab template within the document. Such an operation is time-consuming and cumbersome. Further, the potential for entering incorrect information regarding the position of the tab template may result in errors. Therefore, embodiments herein have been developed that avoid the need for the user to separate the document into segments and/or manually identify the locations of the tab templates. More specifically, embodiments herein provide a machine-readable (scanner-readable) mark, such as a barcode or glyph, that allows the scanner (and/or processor or controller connected to the scanner) to automatically recognize that a tab template has been included within the document. Further, the embodiments herein allow the user to include information regarding the modulus, modulus position, etc. within the tab template. Therefore, with embodiments herein, the user enters all necessary information regarding the tab page on the tab template. Then, when the scanner/processor recognizes the tab template, the scanner/processor takes all necessary information from the tab template, without requiring any additional user intervention or action. This allows the user to simply insert the tab templates at the appropriate locations within the document and place the entire tab template-containing document into the document handler, after which the processor directs the printer to insert a tab media at the appropriate location.

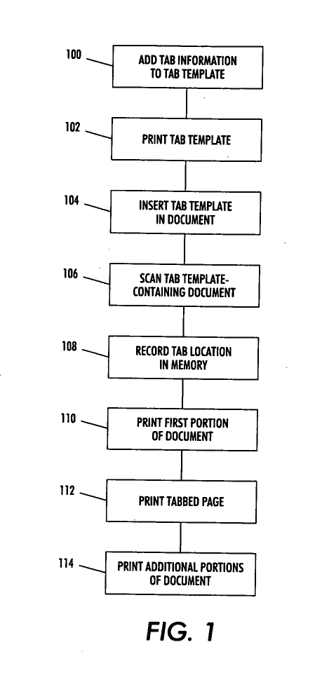

FIG. 1 illustrates various method embodiments herein. In item 100, the method adds tab information to a tab template. For example, this tab information could comprise tab modulus, modulus position, tab location along the edge of the page, and text to be printed on the tab of the tabbed page. The tab template is then printed (item 102) and inserted between pages of a printed document (item 104) by the user. Then all of the tab template-containing document is scanned (item 106) in a single pass (single continuous scanning step) to identify the location of the tab template within the pages of the tab template-containing document. This location is recorded in memory in item 108.

The scanned document is processed (printed or copied) through a printing device in items 110-114. More specifically, in item 110 a first portion of the document (up to the page before where a tab page will appear) is printed. Then, a tabbed page is inserted at the location of the tab template in printed copies of the tab template-containing document (item 112). Next, additional pages of the document are printed until the next tabbed page, or until the end of the document in item 114.

The scanning in item 106 identifies pages of the printed copies between which the tabbed page will be inserted by noting a relative position of the tab template within the pages of the tab template-containing document. In addition, the scanning process 106 correlates the tab information printed on the tab template (e.g., tab text, tab modulus, tab position, etc.) with the relative location of the tab template in the document so that the tab information is printed on the tabbed page. The tab template contains machine-readable markings (such as barcodes and/or glyphs) identifying the tab template as a tab template page. The added media identifier (i.e. barcode) will not be marked on the tab. The image can, for example, be shifted so that the tab portion of the template will be on the physical tab of the paper. If the barcode is put within that shifted amount, above or below the physical tab it will be put on the transfer belt as part of the image but will not be marked on the physical page since there will be nothing for it to be marked on.

As mentioned above, with embodiments herein, the position of the tab can be defined uniquely for each tab sheet. Therefore, the embodiments herein are not required to obey requirements of tabs beginning at the top and end at the bottom of an edge of the sheet. To the contrary, with embodiments herein, the user is free to position the tabs and whatever location the user desires, and in any order desired.

Each printer/copier maintains the modulus and modulus position of its tab stock in each tray. If a tab template that is identified as modulus 5 (5 possible tab positions), modulus position 3, the controller will find the tab media with a modulus of 5. The controller will select the appropriate tab tray and based on its current modulus position in the tray, it will purge the appropriate tabs from the tray to get to the modulus position that is requested. Purge sheets attempt to go to a location other than that of the final job so they are not mixed into the job. There is also logic so that if more than one tray has the same modulus it will select the one that will have to purge the least. For example, if a tray has modulus 5, position 1, and there is a request is for modulus 5 position 3, the tray will purge the tab with modulus 5, position 1 and tab with modulus 5, position 2 and then position 3 will be selected and marked as the user requested.

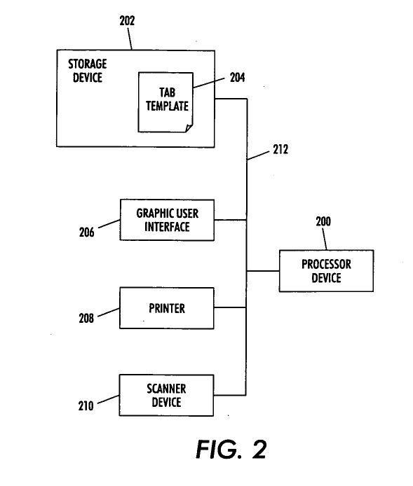

A system embodiment is shown in FIG. 2. The system includes a processor/controller 200, storage 202 that stores in addition to other items, the tab template 204, a graphic user interface 206 used to receive tab information from the user that is to be added to the tab template 204, a printer 208 used to print the tab template 204, and a scanner 210 that scans the tab template-containing document.

The tab template 204 contains scanner or controller-identifiable markings identifying the tab template 204 as a tab template 204 page. Under control of the processor 200, the scanner 210 can identify the location of the tab template 204 within pages of the tab template-containing document. The scanner 210 so identifies pages of the printed copies between which the tabbed page will be inserted, by noting a relative position of the tab template 204 within the pages of the tab template-containing document when scanning the tab template-containing document. The scanner 210 correlates the tab information with the location of the tab template 204 such that the tab information is printed on the tabbed page.

The printer 208 inserts a tabbed page at a location of the tab template 204 in printed copies of the tab template-containing document. The tab information comprises text to be printed on the tab and/or other locations on the tabbed page. The various system components are operatively connected to one another by internal wiring or wired or wireless network connections as illustrated by item 212.

Further, while tab templates are used in the foregoing examples, one ordinarily skilled in the art would understand that different media such as transparencies, different paper thicknesses, different paper colors, etc. could be used in place of the tab paper stock. The barcode on the template can be eliminated by software processes or the template can be larger than the remaining printed document and the bar code can appear on a portion of the template that extends beyond the pages of the printed document. Thus, the bar code will not appear on the inserted media.

Therefore, embodiments herein substantially automate the process of preparing and copying documents that include tabbed pages. With the embodiments herein, the user only needs to insert the tab template sheet at the correct location within a printed document. After this simple operation, the document can be handled automatically from that point forward. For example, once the user creates the tab template-containing document, the user only needs to place the tab template containing-document within the scanner of a copier apparatus and press the start button. Thereafter, the copier will automatically print the tabbed and non-tabbed pages and insert the tabbed pages at the appropriate location(s) within the document.

It will be appreciated that the above-disclosed and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method comprising:
adding information to a template;
printing said template;
inserting said template between pages of a printed document to produce a template-containing document;
scanning said template-containing document to produce a scanned document, wherein said scanning identifies a location of said template within said pages of said template-containing document; and
processing said scanned document through at least one printing device, such that a media page is inserted at a location of said template in printed copies of said template-containing document.

2. The method in claim 1, wherein said scanning identifies pages of said printed copies between which said media page will be inserted by noting a relative position of said template within said template-containing document.

3. The method in claim 1, wherein said scanning correlates said information with said location of said template such that said information is printed on said media page.

4. The method in claim 1, wherein said template contains machine-readable markings identifying said template as a template page.

5. The method in claim 1, wherein said tab information comprises text to be printed on said media page.

6. A method comprising:
adding tab information to a tab template, wherein said tab information comprises tab modulus and tab location;
printing said tab template;
inserting said tab template between pages of a printed document to produce a tab template-containing document;
scanning all of said tab template-containing document in a single pass to produce a scanned document, wherein said scanning identifies a location of said tab template within said pages of said tab template-containing document; and
processing said scanned document through at least one printing device, such that a tabbed page is inserted at a location of said tab template in printed copies of said tab template-containing document.

7. The method in claim 6, wherein said scanning identifies pages of said printed copies between which said tabbed page will be inserted by noting a relative position of said tab template within said pages of said tab template-containing document.

8. The method in claim 6, wherein said scanning correlates said tab information with said location of said tab template such that said tab information is printed on said tabbed page.

9. The method in claim 6, wherein said tab template contains machine-readable markings identifying said tab template as a tab template page.

10. The method in claim 6, wherein said tab information comprises text to be printed on said tabbed page.

11. A system comprising:
a processor;
a storage operatively connected to said processor, wherein said storage is adapted to store a tab template;
a graphic user interface operatively connected to said processor, wherein said graphic user interface is adapted to receive tab information to be added to said tab template;
a printer operatively connected to said processor, wherein said printer is adapted to print said tab template; and
a scanner operatively connected to said processor, wherein said scanner is adapted to scan a tab template-containing document,
wherein said scanner is further adapted to, under control of said processor, identify a location of said tab template within pages of said tab template-containing document, and
wherein said printer is further adapted to insert a tabbed page at a location of said tab template in printed copies of said tab template-containing document.

12. The system in claim 11, wherein said scanner is further adapted to, under control of said processor, identify pages of said printed copies between which said tabbed page will be inserted by noting a relative position of said tab template within said pages of said tab template-containing document.

13. The system in claim 11, wherein said scanner is further adapted to correlate said tab information with said location of said tab template such that said tab information is printed on said tabbed page.

14. The system in claim 11, wherein said tab template contains scanner-identifiable markings identifying said tab template as a tab template page.

15. The system in claim 11, wherein said tab information comprises text to be printed on said tabbed page.

16. A system comprising:
a processor;
a storage operatively connected to said processor, wherein said storage is adapted to store a tab template;
a graphic user interface operatively connected to said processor, wherein said graphic user interface is adapted to receive tab information to be added to said tab template, wherein said tab information comprises tab modulus and tab location;
a printer operatively connected to said processor, wherein said printer is adapted to print said tab template; and
a scanner operatively connected to said processor, wherein said scanner is adapted to scan all of a tab template-containing document in a single pass,
wherein said scanner is further adapted to, under control of said processor, identify a location of said tab template within pages of said tab template-containing document, and
wherein said printer is further adapted to insert a tabbed page at a location of said tab template in printed copies of said tab template-containing document.

17. The system in claim 16, wherein said scanner is further adapted to, under control of said processor, identify pages of said printed copies between which said tabbed page will be inserted by noting a relative position of said tab template within said pages of said tab template-containing document.

18. The system in claim 16, wherein said scanner is further adapted to correlate said tab information with said location of said tab template such that said tab information is printed on said tabbed page.

19. The system in claim 16, wherein said tab template contains scanner-identifiable markings identifying said tab template as a tab template page.

20. The system in claim 16, wherein said tab information comprises text to be printed on a tab of said tabbed page.
